(19) United States
(12) Patent Application Publication
(10) Pub. No.: US 2004/0226667 A1
(43) Pub. Date: Nov. 18, 2004

(54) Mounting bracket and headrail for a window covering

(76) Inventor: James D. Tyner, Clermont, FL (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/438,672

(22) Filed: May 15, 2003

(51) Int. Cl. E06B 9/30

(52) U.S. Cl. 160/178.1 R

(57) ABSTRACT

A mounting bracket has a rear plate and a top plate extending forwardly from an upper edge of the rear plate. The top plate has a front tab sized to fit within a slot near the top front edge of a headrail. A flexible finger extends from the top plate, the finger has a finger tab that is sized and positioned so that when the front tab is within the slot in the headrail, the finger tab will engage the bottom edge of the headrail. The finger can be flexed toward the rear plate to release the headrail. The headrail preferably is a symmetrical metal extrusion having a lip attached to each of the front and rear edges of the top of the headrail. The lips each form the slot into which the front tab of the bracket is placed.

### FIELD OF INVENTION

The invention relates to a headrail for window coverings such as pleated shades, roman shades and venetian blinds and the brackets used to mount the headrail on a window frame.

### BACKGROUND OF THE INVENTION

Headrails for window coverings generally are elongated metal structures having a front wall and a bottom with some headrails also having a rear wall parallel to the front wall. These headrails are mounted on the window frame with brackets that either attach to the ends of the headrail or to the walls of the headrail at selected intervals. One common type of bracket is an L-shaped structure having hooks at either end. An example of such a prior art bracket is shown in U.S. Pat. No. 5,533,560 to Morris. That bracket has a rear wall with a spring arm extending from the rear wall. This arm can flex toward and away from the rear wall. A top extends from the upper edge of the rear wall. There is a hook on the outer edge of the top and a hook on the end of the spring arm. The headrail is seated in the hook on the spring arm and a rolled edge on the front wall of the headrail fits into the hook on the top. A headrail is installed on this prior art bracket by first placing the rolled edge of the front wall on the hook on the top and then pivoting the headrail back towards the rear wall until a rail on the bottom edge of the headrail catches within the hook on spring arm. Typically, there will be a notch in the top of the bracket into which the top edge of the rear wall of the headrail fits. This notch arrangement means that the headrail cannot move toward and away from the rear wall of the bracket. Should the width of the headrail be out of specification the rear wall of the headrail must be flexed to fit within the notch. But, at the ends of the headrail and near the cradles the headrail may not flex. Therefore, the bracket cannot be placed at these locations even though these locations are the positions where the most support is needed.

Another L-shaped mounting bracket is disclosed by Anderson in U.S. Pat. No. 5,353,857. This bracket has a tab along the front edge of the top plate and a shoulder at the bottom edge of the rear wall. Tabs extend from the top plate near the tab toward the rear wall.

Yet another L-shaped mounting bracket is disclosed by Wada in U.S. Pat. No. 5,186,424. A slide block is held by the top plate. The slide block is spring biased and slides from a supporting position in which the slide block has moved away from the rear wall to a release position in which the slide block is retracted toward the rear wall. This multipiece mounting bracket requires assembly and is relatively expensive.

In U.S. Pat. No. 5,060,710 an L-shaped mounting bracket is shown that has a cam attached to the rear wall of the bracket. A hook on the front edge of the top of the bracket engages one wall of the headrail. The cam locks against a rail on the opposite side of the headrail. The bracket has three pieces, the L-shaped body, the cam and the rivet which attaches the cam to the bracket body. Thus, assembly is required.

There is a need for a one-piece mounting bracket for holding a headrail of a window blind. Preferably, the mounting racket is a plastic molded component. The mounting bracket should be suitable for attachment at any point along the length of the headrail. The bracket should also be able to be ceiling mounted or wall mounted on a window frame.

The bracket should be able to hold a headrail that is an elongated metal or plastic extrusion. This headrail could have a lip or tab that is engaged by the bracket.

### SUMMARY OF THE INVENTION

I provide a bracket for holding a headrail in which a top plate extends forwardly from the upper edge of a rear plate forming an L-shaped body. The top plate has a tab along a front edge of the top plate. A flexible finger extends from the top plate, the finger having a finger tab. There is a shoulder on the finger tab that is spaced apart from and substantially parallel to the top plate. The finger is capable of being flexed toward the rear plate. Mounting holes can be provided in both the top plate and the rear plate to enable either a wall mount or a ceiling mount.

I further provide a headrail for use in combination with two or more of my mounting brackets. This elongated headrail has a front wall, a rear wall and a top extending between the front wall and the rear wall, the front wall and the top are attached along a front edge. A lip is attached to either the front wall or the top and forms a slot between the top and the lip. The tab on the front edge of the top of the bracket fits in the slot. The finger extending from the top of the bracket engages the bottom edge of the rear wall.

Other objects and advantages of the present invention will become apparent from a description of the present preferred embodiment shown in the drawings.

### BRIEF DESCRIPTION OF THE FIGURES

FIG. 1 is a perspective view of a present preferred embodiment of my bracket showing the top and rear thereof.

FIG. 2 is a perspective view of the present preferred embodiment of my bracket showing the underside thereof.

FIG. 3 is a perspective view of a present preferred headrail held by a pair of brackets of the type shown in FIGS. 1 and 2.

FIG. 4 is a sectional view taken along the line IV—IV in FIG. 3.

FIG. 5 is a sectional view similar to FIG. 4 in which the headrail is partially removed from the brackets.

### DESCRIPTION OF THE PREFERRED EMBODIMENTS

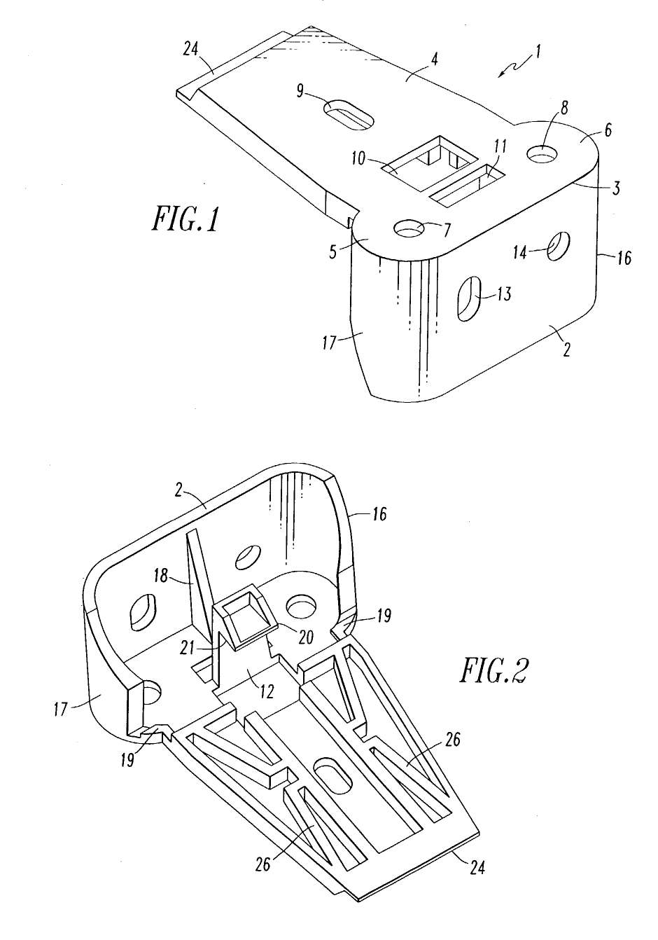

Referring to FIGS. 1 and 2, a present preferred embodiment of my mounting bracket 1 has a rear plate 2 with an upper edge 3 to which top plate 4 is attached. The top plate 4 has a generally T-shaped configuration in which curved wings 5 and 7 form the top of the T-shape. Ceiling mounting holes 7 and 8 and slot 9 are provided in the top plate 4. Holes 10 and 11 are provided in the top plate adjacent to finger 12 to enable the bracket to be easily molded of plastic in a two-piece mold. Wall mount holes 13 and 14 are provided in the rear plate. I prefer to provide curved sidewalls 16: and 17 that extend from opposite sides of the rear plate 2 to top plate 4. The sidewalls provide added strength to the bracket while allowing easy access to ceiling mounting holes 7 and 8. I also prefer to provide a reinforcing rib 18, which can be seen in FIG. 2, between the top plate and rear plate. Finger 12 extends from the top plate 4 and has a finger tab 20 with shoulder 21 at the lower end of the finger. This finger 12 can flex toward the rear plate when pushed in that direction. As can be seen in FIG. 2, the finger tab 19 is configured to have angled sides and a straight back to provide maximum strength with minimal material. There is a front tab, 24 on the front edge of the top plate. Reinforcing ribs 26 can be provided on the underside of the top plate 4.

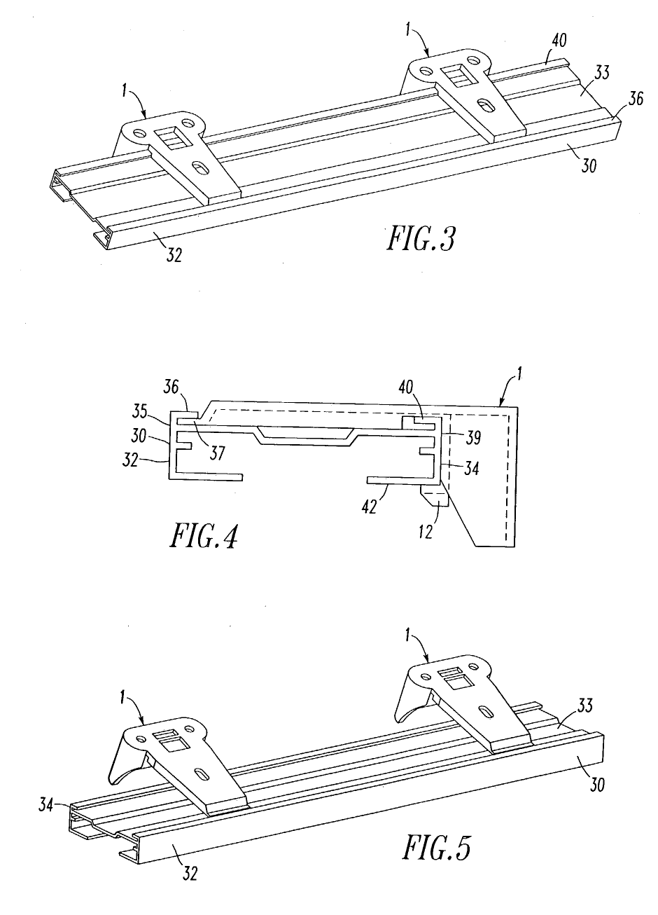

As shown in FIGS. 3, 4 and 5, I prefer to provide an elongated headrail 30 having a front wall 32, a rear wall 34 and a top 33 extending between the front wall and the rear wall. A lip 36 attached to the joint 35 between the front wall 32 and the top 33 forms a slot 37 between the top and the lip. This lip could be offset from the joint 35 between the front wall and the top and attached to only the front wall or only to the top. A second lip 40 is provided at the joint 39 between the rear wall 34 and the top forming slot 41. Consequently, the headrail 30 is symmetrical. The headrail 30 preferably is a metal extrusion. When the headrail 30 is mounted on the brackets 1 the bottom edge 42 of the rear wall 34 rests on shoulder 21 of finger tab 12 of each bracket, while the front tab 24 of the mounting bracket is in slot 37 of he headrail. The second lip 40 is in slot 19 such that the headrail is retained from movement toward or away from the rear plate of the bracket. Slot 19 should be somewhat longer than top 40. In a preferred embodiment slot 19 is 0.270 inches while lip 40 is 0.185 inches.

To remove the headrail 30 from the mounting brackets 1 a user pushes finger tab 12 on each bracket toward rear plate 2 of the mounting bracket 1. This allows the rear wall of the headrail to move down removing lip 40 from slot 19 as shown in FIG. 5. As the rear of the headrail moves down, the headrail may also move forward a small distance. When lip 40 is out of slot 19, the headrail can be pulled forward until front tab 24 of the mounting bracket is no longer in slot 37 of the headrail.

The present mounting bracket is a unitary part that can be molded in a two-piece mold. The bracket can be made of any plastic which provides adequate strength such as polycarbonate or polyvinyl chloride. Consequently, the bracket can be inexpensively produced.

While I have shown and described certain present preferred embodiments of my mounting bracket, it should be understood that my invention is not limited thereto, but may be variously embodied within the scope of the following claims.

I claim:

1. A headrail and bracket system for window coverings comprising:
an elongated headrail having a front wall, a rear wall and a top extending between the front wall and the rear wall, the front wall and the top being attached along a front edge and a lip attached to at least one of the front wall and the top, the lip forming a slot between the top and the lip, the rear wall having a bottom edge, and
at least one mounting bracket, each mounting bracket having a rear plate and a top plate extending forwardly from an upper edge of the rear plate, the top plate having a front tab sized to fit within the slot of the headrail, the mounting bracket further comprising a flexible finger extending from the top plate, the finger having a finger tab, wherein the finger is sized and positioned so that when the front tab is within the slot in the headrail, the finger tab will engage the bottom edge of the headrail, and the finger can be flexed toward the rear plate to release the headrail.

2. The headrail and bracket system of claim 1 wherein the rear plate and the top plate each have mounting holes.

3. The headrail and bracket system of claim 1 wherein the finger tab has a shoulder extending substantially perpendicular to the finger, a straight back and a pair of sidewalls extending from a front edge of the shoulder to the straight back.

4. The headrail and bracket system of claim 1 also comprising a pair of spaced apart sidewalls each attached to the rear plate and the top plate.

5. The headrail and bracket system of claim 1 wherein the top plate has a first width adjacent the top plate, has a second width adjacent the front tab and the second width is less than the first width.

6. The headrail and bracket system of claim 1 wherein the at least one mounting bracket is a unitary plastic molded part.

7. The headrail and bracket system of claim 6 wherein the plastic is a polycarbonate.

8. The headrail and bracket system of claim 1 also comprising at least one reinforcing rib attached to at least one of the top plate and the rear plate.

9. The headrail and bracket system of claim 1 wherein the finger is substantially parallel to the rear plate.

10. A bracket for mounting a headrail of a window covering comprising:
a rear plate having an upper edge;
a top plate extending forwardly from the upper edge of the rear plate, the top plate having a tab along a front edge of the top plate; and
a flexible finger extending from the top plate, the finger having a finger tab, the finger tab having a shoulder spaced apart from and substantially parallel to the top plate, the finger capable of being flexed toward the rear plate.

11. The bracket of claim 10 wherein the rear plate and the top plate each have mounting holes.

12. The bracket of claim 10 also comprising a pair of spaced apart sidewalls attached to the rear plate and the top plate.

13. The bracket of claim 10 wherein the top plate has a first width adjacent the top plate, has a second width adjacent the front tab and the second width is less than the first width.

14. The bracket of claim 10 wherein the at least one mounting bracket is a unitary plastic molded part.

15. The bracket of claim 14 wherein the plastic is a polycarbonate.

16. The bracket of claim 10 also comprising at least one reinforcing rib attached to at least one of the top plate and the rear plate.

17. The bracket of claim 10 wherein the finger is substantially parallel to the rear plate.

18. The bracket of claim 10 wherein the top plate has a molding hole on each side of the finger.
